(19) United States
(12) Patent Application Publication
(10) Pub. No.: US 2025/0380051 A1
(43) Pub. Date: Dec. 11, 2025

(54) INFORMATION PROCESSING APPARATUS, INFORMATION PROCESSING SYSTEM, INFORMATION PROCESSING METHOD, AND NON-TRANSITORY COMPUTER READABLE MEDIUM

(71) Applicant: NEC Corporation, Minato-ku, Tokyo (JP)

(72) Inventor: Masato SASAKI, Tokyo (JP)

(73) Assignee: NEC Corporation, Minato-ku, Tokyo (JP)

(21) Appl. No.: 18/878,943

(22) PCT Filed: Sep. 15, 2022
(86) PCT No.: PCT/JP2022/034646

§ 371 Date: Dec. 26, 2024

(51) Int. Cl. H04N 23/60; H04N 23/67

(52) U.S. Cl. CPC H04N 23/64; H04N 23/67

(57) ABSTRACT

An information processing apparatus (102) includes an acquisition unit (121), and an estimation unit (123). The acquisition unit (121) acquires a target image acquired by photographing a target by a photographing apparatus (101) as a photographing unit. The estimation unit (123) estimates deviation of a focus during photographing of the target image by using a training model that has been trained for deriving deviation of a focus during photographing of the target image by using, as an input, a first input image to be acquired from the target image.

### TECHNICAL FIELD

The present disclosure relates to an information processing apparatus, an information processing system, an information processing method, and a storage medium.

### BACKGROUND ART

Various techniques for automatically adjusting a focus during photographing have been proposed.

For example, a recognition apparatus described in Patent Document 1 “acquires the recognition information from the photographing unit at an interval of a predetermined moving distance of the focus position, and outputs an recognition result after recognition processing for a same person to be recognized is performed once or a plurality of times”.

For example, Patent Document 2 describes that, in order to adjust a focus on a desired region in an iris region, a pupil region, or a scleral region, “utilizing that data in which contrast (or luminance) is different from each other are acquired from an image photographed at a plurality of focus positions”.

For example, an imaging apparatus described in Patent Document 3 includes a focus detection unit that detects focus position information of a photographing optical system, and a control unit that controls a photographing operation. In a case where a photographing magnification is equal to or more than a predetermined magnification, the control unit causes to start a photographing operation at second timing earlier, by a predetermined time, than first timing when the photographing optical system becomes substantially in a focus state, based on a plurality of detection results acquired by a plurality of times of detection operations by the focus detection unit.

### RELATED DOCUMENT

### Patent Document

Patent Document 1: Japanese Patent Application Publication No. 2008-052317
Patent Document 2: Japanese Patent Application Publication No. 2007-093874
Patent Document 3: Japanese Patent Application Publication No. 2006-162681

### SUMMARY

### Technical Problem

An object of the present disclosure is to improve the techniques described in the above-described related documents.

### Solution to Problem

One aspect of the present invention provides an information processing apparatus including:
an acquisition unit that acquires a target image acquired by photographing a target by a photographing unit; and
an estimation unit that estimates deviation of a focus during photographing of the target image by using a training model that has been trained for deriving deviation of a focus during photographing of the target image by using, as an input, a first input image to be acquired from the target image.

One aspect of the present invention provides an information processing method including,
by one or more computers:
acquiring a target image acquired by photographing a target by a photographing unit; and
estimating deviation of a focus during photographing of the target image by using a training model that has been trained for deriving deviation of a focus during photographing of the target image by using, as an input, a first input image to be acquired from the target image.

One aspect of the present invention provides a storage medium storing a program for causing one or more computers to execute:
acquiring a target image acquired by photographing a target by a photographing unit; and
estimating deviation of a focus during photographing of the target image by using a training model that has been trained for deriving deviation of a focus during photographing of the target image by using, as an input, a first input image to be acquired from the target image.

### BRIEF DESCRIPTION OF THE DRAWINGS

FIG. 1 is a diagram illustrating an overview of an information processing system according to an example embodiment 1.

FIG. 2 is a diagram illustrating an overview of an information processing apparatus according to the example embodiment 1.

FIG. 3 is a flowchart illustrating an overview of an information processing method according to the example embodiment 1.

FIG. 4 is a diagram illustrating a configuration example of the information processing system according to the example embodiment 1.

FIG. 5 is a diagram illustrating a functional configuration example of a photographing apparatus according to the example embodiment 1.

FIG. 6 is a diagram illustrating one example of a binocular image being a target image according to the example embodiment 1.

FIG. 7 is a diagram illustrating one example of image information according to the example embodiment 1.

FIG. 8 is a diagram illustrating a functional configuration example of the information processing apparatus according to the example embodiment 1.

FIG. 9 is a diagram illustrating one example of a right iris image to be detected as a first input image according to the example embodiment 1.

FIG. 10 is a diagram illustrating a physical configuration example of the photographing apparatus according to the example embodiment 1.

FIG. 11 is a diagram illustrating a physical configuration example of the information processing apparatus according to the example embodiment 1.

FIG. 12 is a flowchart illustrating one example of first photographing processing according to the example embodiment 1.

FIG. 13 is a flowchart illustrating one example of focus control processing according to the example embodiment 1.

FIG. 14 is a flowchart illustrating one example of second photographing processing according to the example embodiment 1.

FIG. 15 is a diagram illustrating a functional configuration example of an information processing apparatus according to a modification example 1.

FIG. 16 is a diagram illustrating a functional configuration example of an information processing apparatus according to an example embodiment 2.

FIG. 17 is a flowchart illustrating one example of focus control processing according to the example embodiment 2.

FIG. 18 is a diagram illustrating a functional configuration example of the information processing apparatus according to the example embodiment 2.

FIG. 19 is a flowchart illustrating one example of focus control processing according to an example embodiment 3.

FIG. 20 is a diagram illustrating a functional configuration example of an information processing apparatus according to an example embodiment 4.

FIG. 21 is a flowchart illustrating one example of focus control processing according to the example embodiment 4.

FIG. 22 is a diagram illustrating a functional configuration example of an information processing apparatus according to an example embodiment 5.

FIG. 23 is a flowchart illustrating one example of focus control processing according to the example embodiment 5.

FIG. 24 is a diagram illustrating a functional configuration example of an information processing apparatus according to an example embodiment 6.

FIG. 25 is a diagram illustrating a functional configuration example of a control unit according to the example embodiment 6.

FIG. 26 is a flowchart illustrating one example of focus control processing according to the example embodiment 6.

### EXAMPLE EMBODIMENT

Hereinafter, example embodiments according to the present invention are described by using the drawings. Note that, in all drawings, a similar constituent element is indicated by a similar reference sign, and description thereof is omitted as necessary.

### Example Embodiment 1

### (Overview)

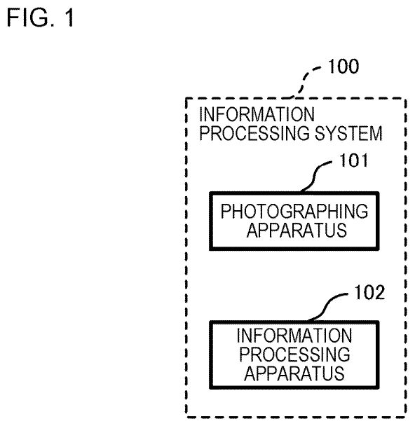

FIG. 1 is a diagram illustrating an overview of an information processing system 100 according to an example embodiment 1. The information processing system 100 includes a photographing apparatus 101 and an information processing apparatus 102.

The photographing apparatus 101 generates a target image by photographing a target.

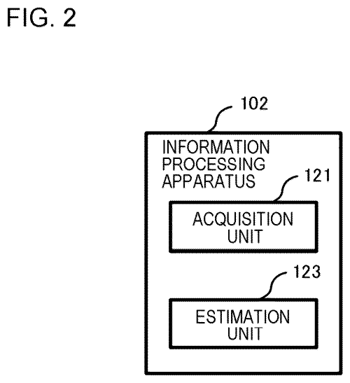

FIG. 2 is a diagram illustrating an overview of the information processing apparatus 102 according to the example embodiment 1. The information processing apparatus 102 includes an acquisition unit 121, and an estimation unit 123.

The acquisition unit 121 acquires a target image acquired by photographing a target by the photographing apparatus 101 as a photographing unit.

The estimation unit 123 estimates deviation of a focus during photographing of the target image by using a training model that has been trained for deriving deviation of a focus during photographing of the target image by using, as an input, a first input image to be acquired from the target image.

The information processing system 100 enables to adjust a focus on a target at a high speed and accurately without depending on a photographing environment. Further, the information processing apparatus 102 enables to adjust a focus on a target at a high speed and accurately without depending on a photographing environment.

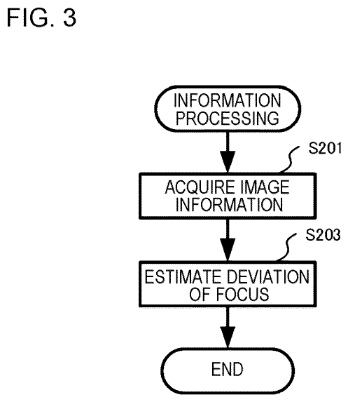

FIG. 3 is a flowchart illustrating an overview of an information processing method according to the example embodiment 1.

The acquisition unit 121 acquires a target image acquired by photographing a target by the photographing apparatus 101 as a photographing unit (step S201).

The estimation unit 123 estimates deviation of a focus during photographing of the target image by using a training model that has been trained for deriving deviation of a focus during photographing of the target image by using, as an input, a first input image to be acquired from the target image (step S203).

The information processing method enables to adjust a focus on a target at a high speed and accurately without depending on a photographing environment.

In the following, a detailed example of the information processing system 100, the information processing apparatus 102, the information processing method, and the like according to the example embodiment 1 is described.

### (Details)

The above-described Patent Document 1 describes that “since it is sufficient to be able to perform recognition after all even when a target is out of focus, it is not necessarily required to adjust a focus up to a level at which a good photo can be taken”. In this way, in the technique described in Patent Document 1, there is a risk that a so-called out-of-focus image in which a focus is not adjusted on a target such as a person to be recognized is photographed.

Generally, in recognition using a target image acquired by photographing a target, there is a risk that various impersonations is performed. Therefore, in an recognition apparatus described in Patent Document 1, there is a risk that an erroneous recognition result is output, in a case where recognition is performed by using an out-of-focus image.

As described above, in the technique described in Patent Document 2, in order to adjust a focus, “acquiring data in which contrast (or luminance) is different from each other from an image photographed at a plurality of focus positions is utilized”.

However, generally, each of contrast and luminance is likely to be affected by a photographing environment. A photographing environment is an environment in a case where photographing is performed, and is, for example, one or a plurality of a photographing target, a photographing apparatus, brightness in a case where photographing is performed, and the like. Regarding a target, for example, clothing or the like of the target affects contrast or luminance. Regarding a photographing apparatus, noise or the like generated by processing or the like of the photographing apparatus affects contrast or luminance.

Therefore, in an recognition apparatus described in Patent Document 2, there is a risk that it is difficult to adjust a focus depending on a photographing environment.

Patent Document 3 describes that, in order to derive start timing of a photographing operation, a camera system side, a subject side, or both of the camera system side and the subject side is moved in an optical axis direction. Therefore, in the technique described in Patent Document 3, a time required for photographing is extended, as compared with photographing in which movement as described above is not required.

One example of an object of the present disclosure has been made in view of circumstances as described above, and to provide an information processing system, an information processing apparatus, an information processing method, a storage medium, and the like that solve any task of (1) adjusting a focus on a target accurately, (2) adjusting a focus on a target without depending on a photographing environment, and (3) adjusting a focus on a target at a high speed.

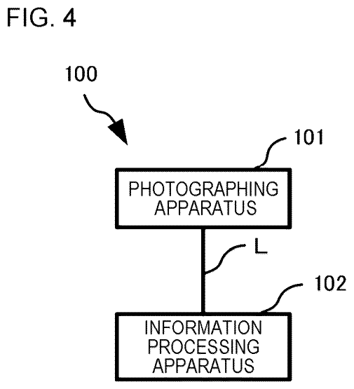

FIG. 4 is a diagram illustrating a configuration example of the information processing system 100 according to the example embodiment 1. The information processing system 100 is a system for generating a target image by photographing a target by automatically adjusting a focus on the target.

The present example embodiment is described by using an example in which a target is a person. Further, the present example embodiment is described by using an example in which a target image (specifically, an image to be generated by photographing a target) is a binocular image. A binocular image is an image including both eyes, and is, for example, an image including both eyes and a periphery thereof. Note that, a target image is not limited to a binocular image, and may be, for example, a monocular image being an image of either one of left and right eyes.

A target image is used, for example, for iris recognition. The present example embodiment is described by using an example in which a right iris image in a binocular image is used for iris recognition.

A right iris image is an iris image of a right eye. An iris image is an image including an iris, and, for example, may be an image including only an iris, or may be an image including an iris and a periphery thereof. A periphery of an iris is, for example, one of, or some or all of a plurality of a white portion of an eye, a pupil, an eyelid, an outer corner of an eye, an inner corner of an eye, and the like.

Note that, a target is not limited to a person, and may be an object. An object may include, for example, an animal such as a dog and a snake. Further, a target image is not limited to a binocular image, and may be a predetermined another part (e.g., a face image) of a target or the entirety of the target. A binocular image may be an image including both eyes, and, for example, may be a face image or the like. Further, an application of a target image is not limited to iris recognition, and may be another biometric recognition (e.g., face recognition) according to the target image, or may be recognition other than biometric recognition. Furthermore, in a case where a target image is used for iris recognition, an iris image of a predetermined one eye or both eyes in a binocular image may be used for iris recognition.

As illustrated in FIG. 4, the information processing system 100 includes the photographing apparatus 101, and the information processing apparatus 102. The photographing apparatus 101 and the information processing apparatus 102 are connected to each other via a communication line L configured by wired connection, wireless connection, or combining these, and mutually transmit and receive information each other via the communication line L.

### (Functional Configuration Example of Photographing Apparatus 101)

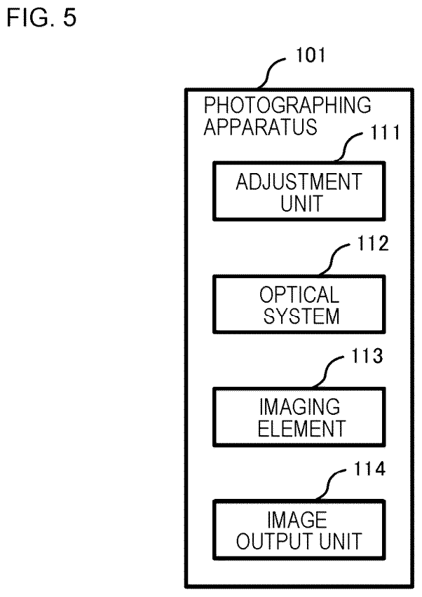

FIG. 5 is a diagram illustrating a functional configuration example of the photographing apparatus 101 according to the example embodiment 1. The photographing apparatus 101 is an apparatus for generating a target image by photographing a target. Specifically, the photographing apparatus 101 according to the present example embodiment is an apparatus for generating a binocular image by photographing a person.

The photographing apparatus 101 may generate a target image by each photographing, for example, by performing photographing at a predetermined cycle such as 40 times or 60 times during one second.

As illustrated in FIG. 5, the photographing apparatus 101 includes an adjustment unit 111, an optical system 112, an imaging element 113, and an image output unit 114.

The adjustment unit 111 adjusts a focus of the optical system 112 by using a control value based on an estimation result of an estimation unit 123 (details thereof are described later). Further, the adjustment unit 111 controls the imaging element 113, and causes the imaging element 113 to perform photographing using an adjusted focus.

The optical system 112 is a configuration for adjusting a focus on a target. The optical system 112 is configured of one or a plurality of device groups that generate an image of a target by utilizing at least one of reflection, refraction, and the like of light.

A focus of the optical system 112 is desirably adjusted on a portion of a target associated with a target image. Therefore, the optical system 112 according to the present example embodiment can also be said to be a configuration for adjusting a focus on both eyes of a person.

The present example embodiment is described by using an example in which the optical system 112 is a liquid lens. A liquid lens is a lens in which a refractive index changes, for example, according to an applied voltage, and consequently, a focal distance changes. Note that, the optical system 112 is not limited to a liquid lens.

The imaging element 113 is an element including a photographing plane on which a target is formed an image through the optical system 112. During photographing, the imaging element 113 generates, from a target, information (specifically, a target image) associated with light incident on a photographing plane through the optical system 112. The imaging element 113 according to the present example embodiment generates, from a region including both eyes of a person, a binocular image associated with light incident on a photographing plane through the optical system 112.

Upon acquiring a target image generated by the imaging element 113, the image output unit 114 outputs image information including the target image. Further, the image output unit 114 outputs the generated image information to the information processing apparatus 102.

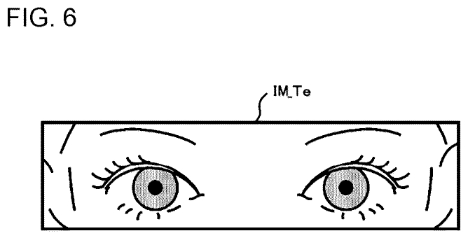

FIG. 6 is a diagram illustrating one example of a binocular image IM_Te being a target image according to the example embodiment 1. The binocular image IM_Te according to the present example embodiment is an image to be generated by the image output unit 114, and includes both eyes of a person.

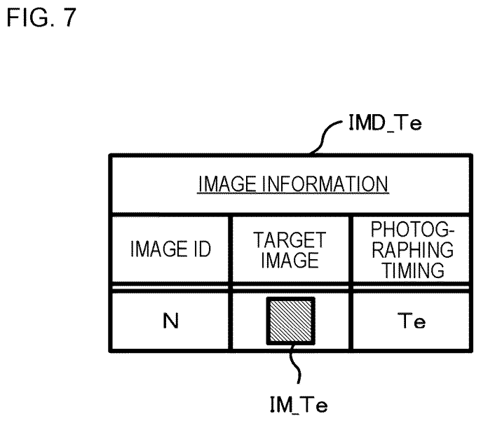

FIG. 7 is a diagram illustrating one example of image information IMD_Te according to the example embodiment 1. The image information IMD_Te illustrated in FIG. 7 is an example including the binocular image IM_Te illustrated in FIG. 6. In the image information IMD_Te illustrated in FIG. 7, an image identification (ID), the binocular image IM_Te, and photographing timing are associated with one another.

An image ID is information (image identification information) for identifying the associated binocular image IM_Te. The image ID is given to an associated binocular image, for example, in accordance with a predetermined rule. The image ID illustrated in FIG. 7 is “N”.

Photographing timing indicates timing Te when photographing for generating the associated binocular image IM_Te has been performed. The photographing timing may be configured of, for example, a date configured of year/month/day, a time, and the like. A time may be, for example, represented by an appropriate scale such as a unit of 1/60 second or a unit of 1/100 second. Note that, the photographing timing may be information substantially indicating timing when the photographing has been performed, and may be, for example, generation timing of a binocular image, generation timing of image information, and the like.

### (Functional Configuration Example of Information Processing Apparatus 102)

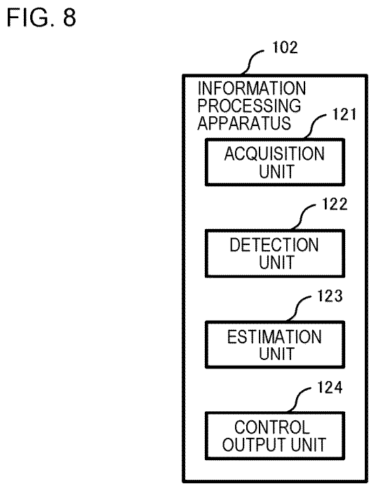

FIG. 8 is a diagram illustrating a functional configuration example of the information processing apparatus 102 according to the example embodiment 1. The information processing apparatus 102 is an apparatus for controlling a focus of the optical system 112 in such a way that the focus of the optical system 112 is adjusted on a target. Herein, “adjusting a focus of the optical system 112 on a target” means so-called focusing, specifically, in the present example embodiment, forming an image of both eyes on a photographing plane by the optical system 112.

The binocular image IM_Te illustrated in FIG. 6 is an example of an image in which a focus is adjusted on both eyes of a person. The information processing apparatus 102 controls the photographing apparatus 101 in such a way as to be able to photograph the binocular image IM_Te as described above.

As illustrated in FIG. 8, the information processing apparatus 102 includes an acquisition unit 121, a detection unit 122, the estimation unit 123, and a control output unit 124.

The acquisition unit 121 acquires a target image acquired by photographing a target by the photographing apparatus 101. The acquisition unit 121 according to the present example embodiment acquires a binocular image from the photographing apparatus 101 by acquiring image information from the photographing apparatus 101.

The detection unit 122 detects a first input image, based on the target image acquired by the acquisition unit 121. A first input image is an image in a predetermined first region regarding a target. A first region is a part or the entirety of the target image, and may be defined according to an application of the target image.

As described above, an application of an image according to the present example embodiment is iris recognition using a right iris image. Therefore, the first region is a region associated with an iris of a right eye. Specifically, a first input image according to the present example embodiment is a right iris image. Further, the detection unit 112 according to the present example embodiment detects a right iris image, based on a binocular image acquired by the acquisition unit 121.

### (First Training Model According to Example Embodiment 1)

As a technique for detecting a right iris image, a general technique such as pattern matching or machine training may be used. Herein, an example using a machine training model is described.

The detection unit 122 detects a first input image by using a first training model that has been trained for detecting the first input image from a target image by using the target image, as an input.

A first training model is a trained machine training model. The first training model performs training for detecting a first input image from a target image by using first training information, as an input. First training information includes a plurality of first training images, and a first correct answer value related to each of the plurality of first training images.

One or more of a plurality of first training images are an image including a same portion as a portion of a target included in a target image. Further, a plurality of first training images desirably include an image photographed in a different photographing environment. A photographing environment includes at least one of a target, and brightness. Note that, brightness in a first training image may be changed by editing the image.

Specifically, for example, the detection unit 122 according to the present example embodiment detects a right iris image by using a first training model that has been trained for detecting a right iris image from a binocular image by using the binocular image, as an input. One or more of first training images according to the present example embodiment are a binocular image. A first correct answer value according to the present example embodiment is, for example, information indicating a position and a region of a right iris image included in a first training image. A photographing environment according to the present example embodiment includes at least one of a person serving as a subject, and brightness.

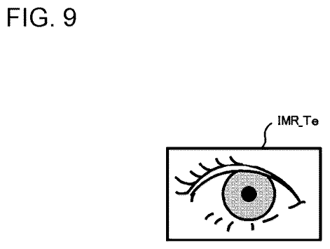

FIG. 9 is a diagram illustrating one example of a right iris image IMR_Te to be detected as a first input image according to the example embodiment 1. The right iris image IMR_Te illustrated in FIG. 9 is one example of a right iris image to be detected based on the binocular image IM_Te illustrated in FIG. 6.

FIG. 8 is referred to again.

The estimation unit 123 estimates deviation of a focus during photographing of a target image by using a second training model that has been trained for deriving deviation of a focus during photographing of the target image by using, as an input, a first input image to be acquired from the target image.

Deviation of a focus includes, for example, an amount (deviation amount) by which a focal distance is deviated, and a direction (deviation direction) in which a focus is deviated.

Deviation according to the present example embodiment is represented by a difference between a current value and a target value of an applied voltage [voltage (V)] to a liquid lens included in the optical system 112.

A target value is an applied voltage in a state in which a focus is adjusted on an eye of a person. In the present example embodiment, since a first input image is a right iris image, the target value is a state in which a focus is adjusted on a right eye or a right iris of a person.

A difference in an applied voltage represents a deviation direction depending on whether a value is a positive value or a negative value. Further, magnitude of a difference in an applied voltage represents a deviation amount of a focus. Note that, an index representing deviation is not limited to an applied voltage [V], and may be set as necessary.

Specifically, for example, the estimation unit 123 acquires a first input image (in the present example embodiment, a right iris image) detected by the detection unit 122. Further, the estimation unit 123 estimates deviation of a focus during photographing of the target image by using a second training model by using the acquired first input image, as an input.

### (Second Training Model According to Example Embodiment 1)

A second training model is a trained machine training model. The second training model performs training for deriving deviation of a focus during photographing of a target image by using second training information, as an input. Second training information includes a plurality of second training images, and a second correct answer value related to each of the plurality of second training images.

One or more of a plurality of second training images are an image including a same portion as a portion of a target included in a first input image. Further, a plurality of second training images desirably include an image photographed in a different photographing environment. As described above, a photographing environment includes at least one of a target, and brightness. Note that, brightness in a second training image may be changed by editing the image.

Specifically, for example, the estimation unit 123 according to the present example embodiment estimates deviation of a focus during photographing of a binocular image by using a second training model that has been trained for deriving deviation of a focus during photographing of the binocular image by using, as an input, a right iris image to be acquired from the binocular image.

One or more of second training images according to the present example embodiment are a right iris image. A second correct answer value according to the present example embodiment is, for example, deviation of a focus during photographing of an iris image included in a second training image. As described above, deviation of a focus includes, for example, a deviation amount and a deviation direction. As described above, a photographing environment according to the present example embodiment includes at least one of a person serving as a subject, and brightness.

Herein, a first training model and a second training model (specifically, a training model used by each of the detection unit 122 and the estimation unit 123) are desirably separated from each other. This means that neural networks (e.g., convolutional neural networks) configuring each of a first training model and a second training model are separated from each other. Separating a first training model and a second training model from each other makes it easy to find out a portion being a cause of a failure, in a case where there is the failure in focus control, and fix the portion.

Note that, a first input image may be a target image. Further, a part of neural networks configuring each of a first training model and a second training model may be commonly used.

FIG. 8 is referred to again.

The control output unit 124 outputs, to the photographing apparatus 101, a control value based on deviation of a focus estimated by the estimation unit 123. The control value is a value for adjusting the deviation of the focus in such a way that the focus of the optical system 112 is adjusted. A control value according to the present example embodiment is, for example, an applied voltage [V] to be acquired by adding a current value of an applied voltage, and a difference in an applied voltage estimated as deviation of a focus.

Specifically, for example, the control output unit 124 may output the above-described control value to the photographing apparatus 101, based on whether an estimation result of the estimation unit 123 satisfies a focusing condition.

A focusing condition includes a criterion for determining whether a focus is adjusted on a target. For example, in a case where an estimation result of the estimation unit 123 is represented by a difference in an applied voltage, the focusing condition may be defined within a range of the applied voltage.

So far, a functional configuration example of the information processing system 100 according to the example embodiment 1 has been mainly described. In the following, a physical configuration example of the information processing system 100 according to the example embodiment 1 is described.

### (Physical Configuration Example of Photographing Apparatus 101)

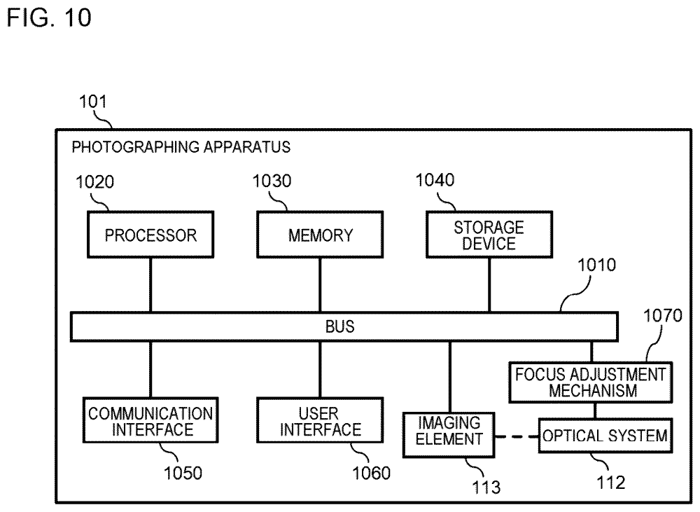

FIG. 10 is a diagram illustrating a physical configuration example of the photographing apparatus 101 according to the example embodiment 1. The photographing apparatus 101 is, for example, a camera. As illustrated in FIG. 10, for example, the photographing apparatus 101 physically includes, a bus 1010, a processor 1020, a memory 1030, a storage device 1040, a communication interface 1050, a user interface 1060, a focus adjustment mechanism 1070, the imaging element 113, and the optical system 112.

The bus 1010 is a data transmission path along which the processor 1020, the memory 1030, the storage device 1040, the network interface 1050, the user interface 1060, and the imaging element 113 mutually transmit and receive data. However, a method of mutually connecting the processor 1020 and the like is not limited to bus connection.

The processor 1020 is a processor to be achieved by a central processing unit (CPU), a graphics processing unit (GPU), or the like.

The memory 1030 is a main storage apparatus to be achieved by a random access memory (RAM) or the like.

The storage device 1040 is an auxiliary storage apparatus to be achieved by a hard disk drive (HDD), a solid state drive (SSD), a memory card, a read only memory (ROM), or the like. The storage device 1040 stores a program module for achieving each function of the photographing apparatus 101. Each function associated with a program module is achieved by causing the processor 1020 to read each program module in the memory 1030 and execute the read program module.

The communication interface 1050 is an interface for connecting to the communication line L.

The user interface 1060 is a touch panel, a keyboard, a mouse, and the like as an interface for allowing a user to input information, and a liquid crystal panel, an organic electro-luminescence (EL) panel, and the like as an interface for presenting information to a user.

The focus adjustment mechanism 1070 is a mechanism for adjusting a focus of the optical system 112, and is a physical configuration for achieving a function of the adjustment unit 111. The focus adjustment mechanism 1070 is configured of an electric circuit or the like that applies a voltage to a liquid lens, for example, in a case where the optical system 112 is a liquid lens.

The imaging element 113 is an element that converts light incident to a photographing plane into an electric signal. The imaging element 113 includes, for example, a charge coupled device (CCD) image sensor, a complementary metal oxide semiconductor (CMOS) image sensor, and the like.

As described above, the optical system 112 includes one or more liquid lenses. The optical system 112 may further include a prism, a mirror, and the like.

Note that, the optical system 112 is not limited to a liquid lens, and may include, for example, one or a plurality of solid lenses formed by using glass, resin, or the like, in place of one or more liquid lenses, or in addition to one or more liquid lenses. The focus adjustment mechanism 1070 in this case may include, for example, a motor for moving one or more solid lenses, a control circuit that controls the motor, and the like. A motor may be various motors such as a voice coil motor. A voice coil motor is one kind of a linear motor, and is able to change a focal distance by moving a lens in a predetermined direction depending on control.

### (Physical Configuration Example of Information Processing Apparatus 102)

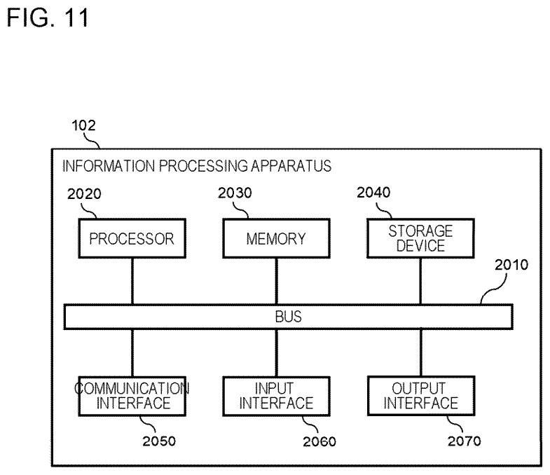

FIG. 11 is a diagram illustrating a physical configuration example of the information processing apparatus 102 according to the example embodiment 1. The photographing apparatus 101 is, for example, a general-purpose computer. As illustrated in FIG. 11, for example, the information processing apparatus 102 physically includes a bus 2010, a processor 2020, a memory 2030, a storage device 2040, a communication interface 2050, an input interface 2060, and an output interface 2070.

The storage device 2040 stores a program module for achieving each function of the information processing apparatus 102. Except for this point, the bus 2010, the processor 2020, the memory 2030, the storage device 2040, and the communication interface 2050 may be respectively similar to the bus 1010, the processor 1020, the memory 1030, the storage device 1040, and the communication interface 1050 of the photographing apparatus 101.

The input interface 2060 is an interface for allowing a user to input information, and includes, for example, a touch panel, a keyboard, a mouse, and the like.

The output interface 2070 is an interface for presenting information to a user, and includes, for example, a liquid crystal panel, an organic electro-luminescence (EL) panel, and the like.

So far, a configuration example of the information processing system 100 according to the example embodiment 1 has been described. In the following, an operation example of the information processing system 100 according to the example embodiment 1 is described.

### (Operation of Information Processing System 100 According to Example Embodiment 1)

The information processing system 100 performs information processing for performing photographing of a target by automatically adjusting a focus. Information processing includes first photographing processing and second photographing processing to be performed by the photographing apparatus 101, and focus control processing to be performed by the information processing apparatus 102.

Information processing as described above is, for example, started upon receiving, from a sensor that detects that a person is present within a predetermined range, a detection signal indicating that a person is detected within the range. Note that, a method of starting information processing is not limited thereto, and another example of the method of starting information processing is described in another example embodiments.

### (Example of First Photographing Processing According to Example Embodiment 1)

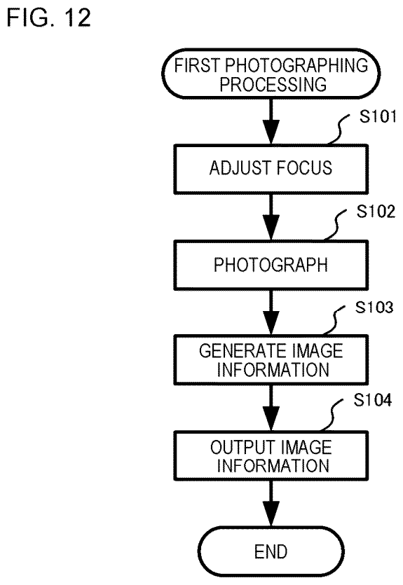

FIG. 12 is a flowchart illustrating one example of the first photographing processing according to the example embodiment 1. The first photographing processing is processing for generating a target image by photographing a target in response to a detection signal. The first photographing processing according to the present example embodiment is processing for generating a binocular image by photographing a person in response to a detection signal.

The adjustment unit 111 adjusts a focus of the optical system 112 at a predetermined value in response to a detection signal (step S101).

Specifically, for example, the adjustment unit 111 applies a voltage of a predetermined value to the optical system 112. This allows the adjustment unit 111 to adjust a focus of the optical system 112 at the predetermined value. Herein, in a case where a person is detected by a sensor, the person is present within a predetermined range. Therefore, the predetermined value may be set in advance, for example, according to a distance between the range and the optical system 112.

The adjustment unit 111 causes the imaging element 113 to perform photographing in a state adjusted in step S101 (step S102).

Specifically, for example, the adjustment unit 111 controls the imaging element 113, and causes the imaging element 113 to generate a target image (in the present example embodiment, a binocular image) associated with an image to be formed on a photographing plane of the imaging element 113. The imaging element 113 outputs the generated target image.

Upon acquiring the target image generated in step S102, the image output unit 114 generates image information including the target image (step S103).

Specifically, for example, the image output unit 114 generates image information by associating an image ID given to the target image, and photographing timing of the target image with the target image (in the present example embodiment, a binocular image) generated in step S102.

The image output unit 114 outputs the image information generated in step S102 to the information processing apparatus 102 (step S104), and finishes the first photographing processing.

Herein, in a case where the first photographing processing is started, as described above, a person is present within a predetermined range. Therefore, it is often a case that a focus is adjusted on a target. Therefore, by performing the first photographing processing, a target image in which a focus is substantially adjusted on a target is generated and output.

(Example of Focus Control Processing according to Example Embodiment 1)

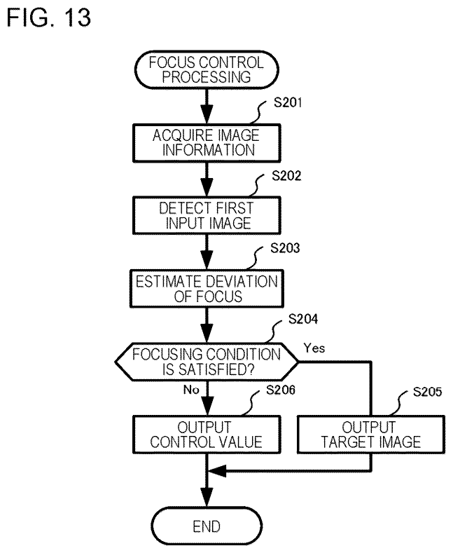

FIG. 13 is a flowchart illustrating one example of the focus control processing according to the example embodiment 1. The focus control processing is processing for controlling a focus of the optical system 112 in such a way that the focus of the optical system 112 is adjusted on a target. The focus control processing is started, for example, in a case where image information is output from the photographing apparatus 101 in step S104.

The acquisition unit 121 acquires image information output in step S104 (step S201).

This allows the acquisition unit 121 to acquire a target image (in the present example embodiment, a binocular image) acquired by photographing a target by the photographing apparatus 101.

The detection unit 122 detects a first input image, based on the target image acquired in step S102 (step S202).

Specifically, for example, as described above, the detection unit 122 according to the present example embodiment detects a right iris image by using a first training model that has been trained for detecting a right iris image from a binocular image by using the binocular image, as an input.

The estimation unit 123 estimates deviation of a focus during photographing performed in step S102 by using a second training model by using, as an input, the first input image detected in step S202 (step S203).

Specifically, for example, as described above, the estimation unit 123 according to the present example embodiment estimates deviation of a focus during photographing performed in step S102 by using a second training model by using, as an input, the right iris image detected in step S202.

The control output unit 124 decides whether an estimation result in step S203 satisfies a focusing condition, based on the focusing condition (step S204).

Herein, the focusing condition is described by a case where a criterion indicating that a focus is adjusted on a target is included, as an example.

In a case where it is decided that the focusing condition is satisfied (step S204; Yes), the control output unit 124 outputs, for example, to unillustrated another apparatus or the like, the target image acquired in step S201 (step S205), and finishes the focus control processing.

Herein, another apparatus is, for example, an apparatus that performs recognition by using a target image.

Note that, the focusing condition may include a criterion indicating that a focus is not adjusted on a target, and in a case where the focusing condition is not satisfied, the control output unit 124 in this case may output, to another apparatus or the like, the target image acquired in step S201. Further, an recognition function may be provided in the information processing apparatus 102.

In a case where the focusing condition is not satisfied (step S204; No), the control output unit 124 generates a control value, based on an estimation result in step S203, outputs the generated control value to the photographing apparatus 101 (step S206), and finishes the focus control processing.

Note that, the focusing condition may include a criterion indicating that a focus is not adjusted on a target, and in a case where the focusing condition is satisfied, the control output unit 124 in this case may output the above-described control value to the photographing apparatus 101.

Performing the focus control processing as described above enables to output a target image to another apparatus or the like in a case where the focusing condition is satisfied, and output a control value to the photographing apparatus 101 in a case where the focusing condition is not satisfied.

Therefore, in a case where a focus is not adjusted on a target image with good accuracy of a degree that satisfies the focusing condition, the photographing apparatus 101 is able to perform photographing by adjusting a focus on a target more accurately by using the control value. Further, in a case where a focus is adjusted on a target image with good accuracy of a degree that satisfies the focusing condition, it is possible to acquire a target image in which a focus is adjusted on a target with good accuracy as described above.

### (Example of Second Photographing Processing According to Example Embodiment 1)

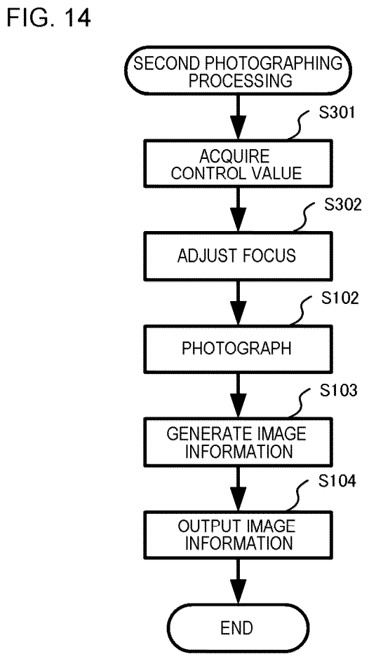

FIG. 14 is a flowchart illustrating one example of the second photographing processing according to the example embodiment 1. The second photographing processing is processing for generating a target image by photographing a target with use of a control value based on an estimation result of the estimation unit 123. The first photographing processing according to the present example embodiment is processing for generating a binocular image by photographing a person with use of a control value to be output in step S206. The second photographing processing is, for example, started in a case where a control value is output from the information processing apparatus 102 in step S206.

The adjustment unit 111 acquires a control value output in step S206 (step S301).

The adjustment unit 111 adjusts a focus of the optical system 112 by using the control value acquired in step S301 (step S302).

Specifically, for example, the adjustment unit 111 applies a voltage to the optical system 112 according to the control value. This enables to adjust a focus of the optical system 112 more accurately than previous photographing with respect to a same target as that during the previous photographing.

The adjustment unit 111 executes step S102 similar to that in the first photographing processing. The image output unit 114 executes pieces of processing of steps S103 to S104 similar to those in the first photographing processing, and finishes the second photographing processing.

In the second photographing processing, it is possible to generate a target image in which a focus is adjusted on a target more accurately than previous photographing.

The focus control processing may be performed again by using a target image generated in the second photographing processing. For example, repeating the focus control processing and the second photographing processing allows the acquisition unit 121 to acquire a plurality of handled images in which a focus is adjusted on a target more accurately in time-series order.

For example, repeating the focus control processing and the second photographing processing until a focusing condition is satisfied (step S204; Yes) enables to acquire a target image in which a focus is adjusted on a target with good accuracy of a degree that satisfies the focusing condition.

Note that, the focus control processing and the second photographing processing may not be repeated again, or may be repeated by setting a predetermined number of times, as an upper limit. These operations enable to photograph a target by adjusting a focus at least once or more times, based on an estimation result using a second training model. Therefore, it is possible to acquire a target image in which a focus is adjusted on a target more accurately than at least previous photographing.

### Advantageous Effect

In the foregoing, according to the present example embodiment, the information processing apparatus 102 includes the acquisition unit 121, and the estimation unit 123. The acquisition unit 121 acquires a target image acquired by photographing a target by the photographing apparatus 101. The estimation unit 123 estimates deviation of a focus during photographing of a target image by using a training model (second training model) that has been trained for deriving deviation of a focus during photographing of the target image by using, as an input, a first input image to be acquired from the target image.

This enables to photograph a target by adjusting a focus, based on an estimation result using the second training model. Performing photographing at an adjusted focus enables to acquire a target image in which a focus is adjusted on a target more accurately than previous photographing. Therefore, it becomes possible to adjust a focus on a target accurately.

Further, since a focus is adjusted by using the second training model, it is possible to perform training using a training image equivalent to various photographing environments. Therefore, it becomes possible to adjust a focus on a target without depending on a photographing environment.

Further, since it is not necessary to perform movement in an optical axis direction as described in Patent Document 3, a focus can be adjusted at a higher speed. Therefore, it becomes possible to adjust a focus on a target at a high speed.

In this way, according to the present example embodiment, it becomes possible to adjust a focus on a target at a high speed and accurately without depending on a photographing environment.

Further, in a case where a target image is photographed by repeatedly adjusting a focus, adjusting a focus by using the second training model enables to acquire a target image in which a focus is adjusted on a target accurately with a smaller number of times of repetition, as compared with a case where a training model is not used. Therefore, it becomes possible to adjust a focus on a target at a high speed.

Further, in a case where a target image is photographed by repeatedly adjusting a focus, adjusting a focus by using the second training model enables to adjust in such a way that a focus is adjusted while tracking movement of a target, even in a case where the target moves. Therefore, it becomes possible to improve tracking ability in a case where a target moves.

According to the present example embodiment, a training model (second training model) is a model that has been trained for estimating deviation of a focus during the photographing by using training information, as an input.

This enables to generate the second training model. Therefore, as described above, it becomes possible to adjust a focus on a target at a high speed and accurately without depending on a photographing environment. Further, it becomes possible to improve tracking ability in a case where a target moves.

According to the present example embodiment, training information includes a plurality of training images, and a correct answer value related to each of the plurality of training images.

This enables to generate the second training model. Therefore, as described above, it becomes possible to adjust a focus on a target at a high speed and accurately without depending on a photographing environment. Further, it becomes possible to improve tracking ability in a case where a target moves.

According to the present example embodiment, a plurality of training images include an image photographed in a different photographing environment.

This enables to generate the second training model that has been trained by using a training image photographed in a different photographing environment. Therefore, it becomes possible to adjust a focus on a target accurately without depending on a photographing environment.

According to the present example embodiment, a photographing environment includes at least one of a target, and brightness.

This enables to generate the second training model that has been trained by using a training image photographed in a photographing environment in which at least one of a target, and brightness is different. Therefore, it becomes possible to adjust a focus on a target accurately without depending on at least one of a target, and brightness.

According to the present example embodiment, the information processing apparatus 102 further includes the detection unit 122 that detects a first input image, based on a target image. A first input image is an iris image.

This enables to acquire a target image by adjusting a focus on a target at a high speed and accurately without depending on a photographing environment. Further, it is possible to perform iris recognition, based on an iris image to be detected from a target image. Therefore, it becomes possible to perform iris recognition at a high speed and accurately without depending on a photographing environment.

Training models (first and second training models) used by each of the detection unit 122 and the estimation unit 123 are separated from each other.

This enables to reduce the number of pieces of processing by each training model, as compared with a case where a training model used by each of the detection unit 122 and the estimation unit 123 is integrated. Therefore, it is possible to speed up the entirety of processing to be performed by the information processing system 100 such as concurrently performing pieces of processing using each training model by speeding up. Therefore, it becomes possible to adjust a focus on a target at a high speed.

Further, separating training models from each other makes it easy to determine a cause in a case where a failure has occurred. Therefore, it becomes possible to make it easy to perform maintenance of the information processing system 100.

According to the present example embodiment, the information processing system 100 includes the photographing apparatus 101, and the information processing apparatus 102. The photographing apparatus 101 generates a target image by photographing a target.

This allows the information processing apparatus 102 to acquire the target image from the photographing apparatus 101. Further, the information processing apparatus 102 may estimate deviation of a focus during photographing of a target image by using a training model (second training model) by using, as an input, a first input image to be acquired from the target image. Consequently, as described above, it becomes possible to adjust a focus on a target at a high speed and accurately without depending on a photographing environment. Further, it becomes possible to improve tracking ability in a case where a target moves.

According to the present example embodiment, the photographing apparatus 101 includes the adjustment unit 111 that adjusts a focus by using a control value based on an estimation result of the estimation unit 123.

This enables to adjust a focus by using the control value. Therefore, as described above, it becomes possible to adjust a focus on a target at a high speed and accurately without depending on a photographing environment. Further, it becomes possible to improve tracking ability in a case where a target moves.

### Modification Example 1

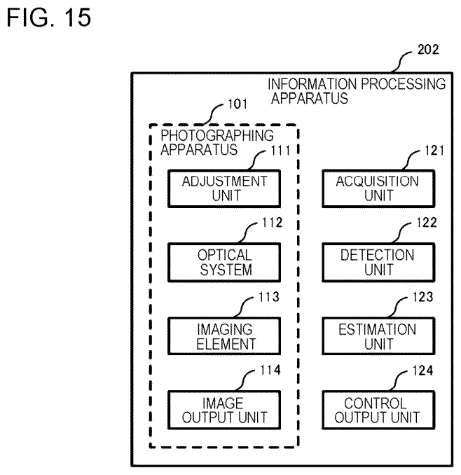

FIG. 15 is a diagram illustrating a functional configuration example of an information processing apparatus 202 according to a modification example 1. The information processing apparatus 202 according to the modification example 1 functionally further includes a configuration included in the photographing apparatus 101 according to the example embodiment 1. The information processing apparatus 202 may physically further include an optical system 112 and an imaging element 113 connected to an internal bus. The information processing apparatus 202 may perform information processing similar to that of the example embodiment 1.

According to the present modification example, the information processing apparatus 202 further includes a photographing apparatus 101. The photographing apparatus 101 generates a target image by photographing a target.

This also provides an advantageous effect similar to that of the example embodiment 1.

### Example Embodiment 2

In the example embodiment 1, an example in which deviation of a focus during photographing of a target image is estimated by using a first input image (right iris image) has been described. An iris diameter may be further used to estimate the deviation of the focus.

In the present example embodiment, in order to simplify description, a point different from the example embodiment 1 is mainly described.

An information processing system according to the present example embodiment includes an information processing apparatus 302, in place of the information processing apparatus 102 according to the example embodiment 1. Except for this point, the information processing system according to the present example embodiment may be configured similarly to the information processing system 100 according to the example embodiment 1.

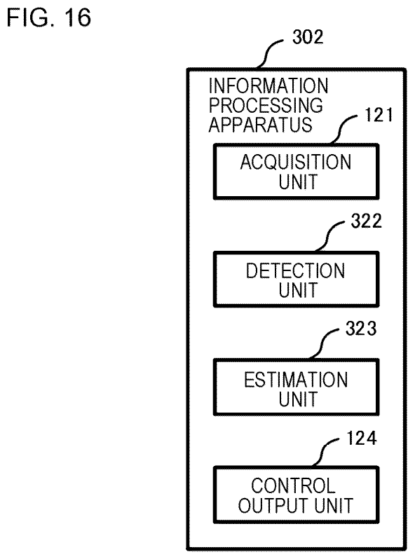

FIG. 16 is a diagram illustrating a functional configuration example of the information processing apparatus 302 according to an example embodiment 2. The information processing apparatus 302 includes a detection unit 322 and an estimation unit 323, in place of the detection unit 122 and the estimation unit 123 according to the example embodiment 1.

Similarly to the example embodiment 1, the detection unit 322 detects a first input image, based on a target image acquired by an acquisition unit 121. The detection unit 322 according to the present example embodiment further detects an iris diameter, based on a first input image. An iris diameter is a diameter or a radius of an iris included in a first input image. An iris diameter may be represented, for example, by a length (e.g., a pixel number) within an image.

The estimation unit 323 estimates deviation of a focus during photographing of a target image by using a second training model that has been trained for deriving deviation of a focus during photographing of the target image by using, as an input, a first input image to be acquired from the target image, and an iris diameter.

The estimation unit 123 according to the present example embodiment estimates deviation of a focus during photographing of a binocular image by using a second training model that has been trained for deriving deviation of a focus during photographing of the binocular image by using, for example, as an input, a right iris image to be acquired from the binocular image, and an iris diameter.

### (Second Training Model According to Example Embodiment 2)

Similarly to the example embodiment 1, a second training model performs training by using second training information, as an input. Second training information includes, in addition to a plurality of second training images, and a second correct answer value related to each of the plurality of second training images, an iris diameter associated with each of the plurality of second training images.

The information processing system according to the present example embodiment may be physically configured similarly to the information processing system 100 according to the example embodiment 1.

### (Operation of Information Processing System According to Example Embodiment 2)

Information processing according to the present example embodiment includes first photographing processing and second photographing processing similar to those of the example embodiment 1, and focus control processing different from that of the example embodiment 1. Also in the present example embodiment, the focus control processing is performed by the information processing apparatus 302.

### (Example of Focus Control Processing According to Example Embodiment 2)

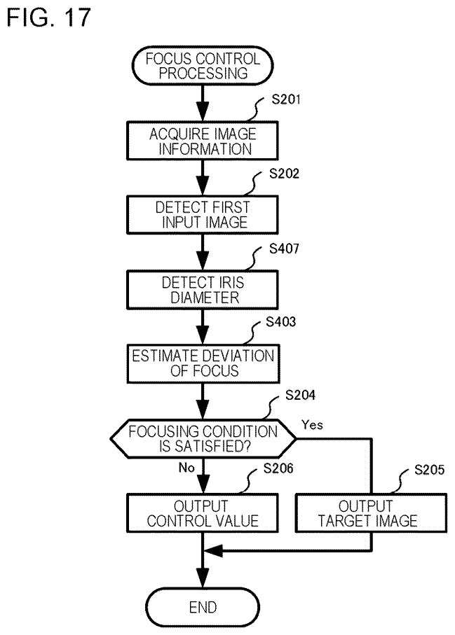

FIG. 17 is a flowchart illustrating one example of the focus control processing according to the example embodiment 2. As illustrated in FIG. 17, the focus control processing according to the present example embodiment includes steps S201 to S202 and steps S204 to S206 similar to those of the example embodiment 1. The focus control processing according to the present example embodiment includes step S407 to be executed following step S202, and step S403 in place of step S203 according to the example embodiment 1.

The detection unit 322 detects an iris diameter, based on a first input image detected in step S202 (step S407).

Specifically, for example, as described above, the detection unit 322 according to the present example embodiment detects a right iris diameter, based on a right iris image. A right iris diameter is an iris diameter of a right eye.

The estimation unit 323 estimates deviation of a focus during photographing performed in step S102 by using a second training model by using, as an input, the first input image and the iris diameter detected in steps S202 and S407 (step S403).

Specifically, for example, as described above, the estimation unit 323 according to the present example embodiment estimates deviation of a focus during photographing performed in step S102 by using a second training model by using, as an input, the right iris image and the right iris diameter detected in steps S202 and S407.

In the focus control processing according to the present example embodiment, deviation of a focus during photographing of a target image is estimated by further using a right iris diameter. This enables to estimate deviation of a focus more accurately as compared with estimating deviation of a focus according to the example embodiment 1.

### Advantageous Effect

In the foregoing, according to the present example embodiment, the detection unit 322 further detects an iris diameter, based on a target image. The estimation unit 323 estimates deviation of a focus by using a training model (second training model) by further using an iris diameter, as an input.

This enables to estimate deviation of a focus more accurately. Therefore, it becomes possible to adjust a focus on a target more accurately.

### Example Embodiment 3

In the example embodiment 1, an example in which deviation of a focus during photographing of a target image is estimated by using a first input image (right iris image) has been described. In order to estimate the deviation of the focus, an amount of change of a control value based on a second input image to be acquired from a past target image, and the past target image may be further used.

In the present example embodiment, in order to simplify description, a point different from the example embodiment 1 is mainly described.

An information processing system according to the present example embodiment includes an information processing apparatus 402, in place of the information processing apparatus 102 according to the example embodiment 1. Except for this point, the information processing system according to the present example embodiment may be configured similarly to the information processing system 100 according to the example embodiment 1.

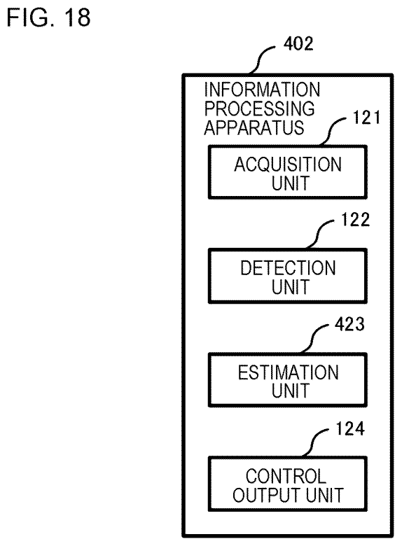

FIG. 18 is a diagram illustrating a functional configuration example of the information processing apparatus 402 according to the example embodiment 2. The information processing apparatus 302 includes an estimation unit 423, in place of the estimation unit 123 according to the example embodiment 1.

The estimation unit 423 estimates deviation of a focus during photographing of a target image by using a second training model by using, as an input, in addition to a first input image, a second input image to be acquired from a past target image, and an amount of change of a control value based on the past target image. Similarly to the example embodiment 1, a second training model is a training model that has been trained for deriving deviation of a focus during photographing of a target image.

A first input image is an image to be acquired from a current target image. A second input image is an image to be acquired from a past target image, and includes a same portion as a portion of a target included in the first input image. Further, a past target image is a target image to be acquired by photographing a common target to the first input image.

The present example embodiment is described by using an example in which a past target image is a target image of a previous time (specifically, a target image generated by photographing immediately earlier than photographing in which a current target image is generated). Further, the present example embodiment is described by using an example in which a target image and a first input image are respectively a binocular image and a right iris image, similarly to the example embodiment 1. In this case, a second input image is also a right iris image.

An amount of change of a control value to be input to a second training model is an amount of change of a control value generated based on a past target image (specifically, a target image serving as a source from which a second input image is detected).

An amount of change of a control value is a difference ΔV (=V1−V2) between a control value V1, and a control value V2 generated based on a target image acquired by photographing a common target earlier than the target image (e.g., immediately earlier than the target image) serving as a source from which a second input image is detected.

Further, in a case where an amount ΔV of change (difference) in a control value is input to a second training model, since the control value V2 is necessary to derive the amount ΔV of change, it is necessary to perform focus control processing and second photographing processing twice or more times. Therefore, in a case where a past target image, and the control values V1 and V2 are not acquired, similarly to the example embodiment 1, the estimation unit 423 may, for example, estimate deviation of a focus during photographing of a target image by using a second training model by using a first input image, as an input. In this case, input to a second training model may further include, for example, a second input image an image acquired by duplicating a first input image, and zero (0) as an amount ΔV of change of a control value.

The estimation unit 423 according to the present example embodiment uses a second training model, for example, by using, as an input, a current right iris image to be acquired from a current binocular image, a previous-time right iris image to be acquired from a previous-time binocular image, and an amount ΔV of change of a control value based on a previous-time target image. Thus, the estimation unit 423 estimates deviation of a focus during photographing of a target image.

### (Second Training Model According to Example Embodiment 3)

Similarly to the example embodiment 1, a second training model performs training by using second training information, as an input. Second training information includes a plurality of second training images, a control value associated with each of the plurality of second training images, and a second correct answer value related to each of the plurality of second training images.

A plurality of second training images may include time-series second training images for each of one or a plurality of targets. In a case where an amount ΔV of change of a control value is input to the second training model, the time-series second training images may be two or more.

The information processing system according to the present example embodiment may be physically configured similarly to the information processing system 100 according to the example embodiment 1.

### (Operation of Information Processing System According to Example Embodiment 3)

Information processing according to the present example embodiment includes first photographing processing and second photographing processing similar to those of the example embodiment 1, and focus control processing different from that of the example embodiment 1. Also in the present example embodiment, the focus control processing is performed by the information processing apparatus 402.

### (Example of Focus Control Processing According to Example Embodiment 3)

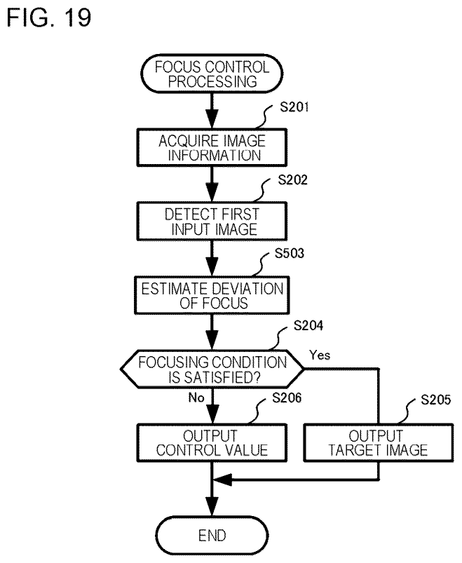

FIG. 19 is a flowchart illustrating one example of the focus control processing according to the example embodiment 3. As illustrated in FIG. 19, the focus control processing according to the present example embodiment includes steps S201 to S202 and steps S204 to S206 similar to those of the example embodiment 1. The focus control processing according to the present example embodiment includes step S503 in place of step S203 according to the example embodiment 1.

The estimation unit 423 estimates deviation of a focus during photographing of a target image by using a second training model by using, as an input, a first input image detected in step S202, a second input image to be acquired from a past target image, and an amount ΔV of change of a control value based on the past target image (step S503).

Specifically, for example, input to the second training model is input of a current right iris image detected in step S202, a previous-time right iris image, and an amount ΔV of change of a control value based on a previous-time binocular image.

Herein, for example, the estimation unit 423 may hold the previous-time right iris image, and the amount ΔV of change of a control value based on a past binocular image related to a common target.

In the focus control processing according to the present example embodiment, deviation of a focus during photographing of a target image is estimated by further using a previous-time right iris image, and an amount ΔV of change of a control value based on a previous-time binocular image. In this way, in a case where adjustment is performed in a direction opposite to a correct direction for adjusting a focus at a previous control value, it is possible to detect this, and correct a focus adjustment direction to the correct direction. Therefore, it is possible to estimate deviation of a focus more accurately, as compared with estimating deviation of a focus according to the example embodiment 1.

### Advantageous Effect

In the foregoing, according to the present example embodiment, a first input image is an image to be acquired from a current target image. The estimation unit 423 estimates deviation of a focus by using a training model (second training model) by further using, as an input, a second input image to be acquired from a target image acquired by photographing a target in a past, and an amount ΔV of change of a control value based on the past target image.

This enables to estimate deviation of a focus more accurately. Therefore, it becomes possible to adjust a focus on a target more accurately.

### Example Embodiment 4

In an example embodiment 4, an example in which the example embodiments 2 and 3 are combined is described. In the present example embodiment, in order to simplify description, a point different from other example embodiments is mainly described.

An information processing system according to the present example embodiment includes an information processing apparatus 502, in place of the information processing apparatus 102 according to the example embodiment 1. Except for this point, the information processing system according to the present example embodiment may be configured similarly to the information processing system 100 according to the example embodiment 1.

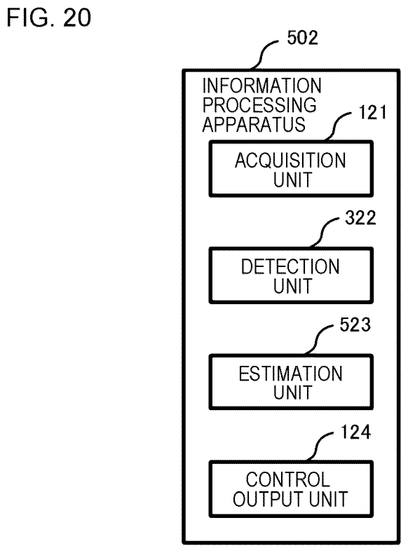

FIG. 20 is a diagram illustrating a functional configuration example of the information processing apparatus 502 according to the example embodiment 4. The information processing apparatus 502 includes a detection unit 322 similar to that of the example embodiment 2, in place of the detection unit 122 according to the example embodiment 1. Further, the information processing apparatus 502 includes an estimation unit 523, in place of the estimation unit 123 according to the example embodiment 1. Except for this point, the information processing system according to the present example embodiment may be configured similarly to the information processing system 100 according to the example embodiment 1.

Similarly to the example embodiment 1, the estimation unit 523 estimates deviation of a focus during photographing of a target image by using a second training model that has been trained for deriving deviation of a focus during photographing of the target image. In the present example embodiment, input to a second training model includes, in addition to a first input image, an iris diameter similar to that of the example embodiment 2, and a second input image to be acquired from a past target image and an amount ΔV of change of a control value based on the past target image similar to that of the example embodiment 3.

The estimation unit 523 according to the present example embodiment uses a second training model, for example, by using, as an input, a current right iris image to be acquired from a current binocular image and a right iris diameter, a previous-time right iris image to be acquired from a previous-time binocular image, and an amount ΔV of change of a control value based on a previous-time target image. This allows the estimation unit 523 to estimate deviation of a focus during photographing of a target image.

### (Second Training Model According to Example Embodiment 4)

Similarly to the example embodiment 1, a second training model performs training by using second training information, as an input. Second training information includes a plurality of second training images, and an iris diameter associated with each of the plurality of second training images. The second training information further includes a control value associated with each of the plurality of second training images, and a second correct answer value related to each of the plurality of second training images.

Similarly to the example embodiment 3, a plurality of second training images may include time-series second training images for each of one or a plurality of targets. In a case where an amount ΔV of change of a control value is input to the second training model, the time-series second training images may be two or more.

The information processing system according to the present example embodiment may be physically configured similarly to the information processing system 100 according to the example embodiment 1.

### (Operation of Information Processing System According to Example Embodiment 4)

Information processing according to the present example embodiment includes first photographing processing and second photographing processing similar to those of the example embodiment 1, and focus control processing different from that of the example embodiment 1. Also in the present example embodiment, the focus control processing is performed by the information processing apparatus 502.

### (Example of Focus Control Processing According to Example Embodiment 4)

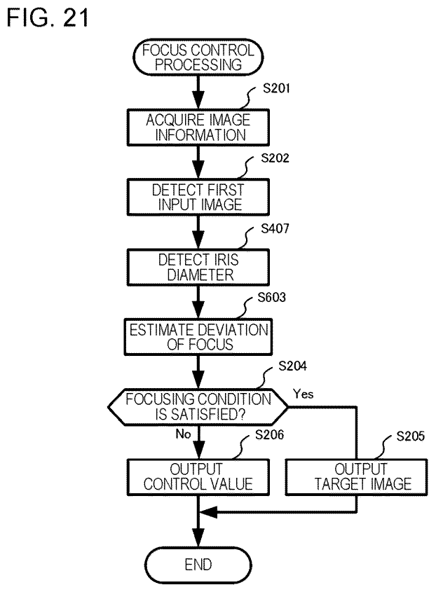

FIG. 21 is a flowchart illustrating one example of the focus control processing according to the example embodiment 4. As illustrated in FIG. 21, the focus control processing according to the present example embodiment includes steps S201 to S202 and steps S204 to S206 similar to those of the example embodiment 1. The focus control processing according to the present example embodiment includes step S407 to be executed following step S202, and step S603 in place of step S203 according to the example embodiment 1.

The detection unit 322 executes step S407 similar to that of the example embodiment 2.

The estimation unit 523 estimates deviation of a focus during photographing of a target image by using a second training model by using, as an input, a first input image and an iris diameter detected in steps S202 and S407, a second input image to be acquired from a past target image, and an amount ΔV of change of a control value based on the past target image (step S603).

Specifically, for example, input to the second training model is a current right iris image and a right iris diameter detected in steps S202 and S407, a previous-time right iris image, and an amount ΔV of change of a control value based on a past binocular image.

Herein, for example, the estimation unit 523 may hold the previous-time right iris image, and the amount ΔV of change of a control value based on the past binocular image related to a common target.

In the focus control processing according to the present example embodiment, deviation of a focus during photographing of a target image is estimated by further using a right iris diameter. This enables to estimate deviation of a focus accurately, similarly to the example embodiment 2.

Further, in the focus control processing according to the present example embodiment, deviation of a focus during photographing of a target image is estimated by further using a previous-time right iris image, and an amount ΔV of change of a control value based on a previous-time binocular image. This enables to estimate deviation of a focus accurately, similarly to the example embodiment 3.

### Advantageous Effect

In the foregoing, according to the present example embodiment, the detection unit 322 further detects an iris diameter, based on a target image. A first input image is an image to be acquired from a current target image. The estimation unit 523 estimates deviation of a focus by using a training model (second training model) by further using, as an input, an iris diameter, a previous-time right iris image, and an amount ΔV of change of a control value based on a previous-time binocular image.

This enables to estimate deviation of a focus more accurately. Therefore, it becomes possible to adjust a focus on a target more accurately.

### Example Embodiment 5

Generally, an operation delay in a photographing apparatus 101 may occur after a control value is output and before photographing based on the control value is performed. For example, in a case where synchronization between a cycle at which a target image is generated in the photographing apparatus 101, and a cycle at which a focus of an optical system 112 is adjusted is not acquired, an operation delay occurs. In a case where an operation delay as described above has occurred, it may be difficult to control according to a control value (vibration of a control value).

In an example embodiment 5, an example in which a value at which correction according to an operation delay in the photographing apparatus 101 is performed with respect to estimated deviation of a focus is set as a control value in order to suppress vibration of a control value as described above is. Although correction as described above can also be applied to other example embodiments, the present example embodiment is described by using an example in which correction is applied to the example embodiment 1.

In the present example embodiment, in order to simplify description, a point different from other example embodiments is mainly described.

An information processing system according to the present example embodiment includes an information processing apparatus 602, in place of the information processing apparatus 102 according to the example embodiment 1. Except for this point, the information processing system according to the present example embodiment may be configured similarly to the information processing system 100 according to the example embodiment 1.

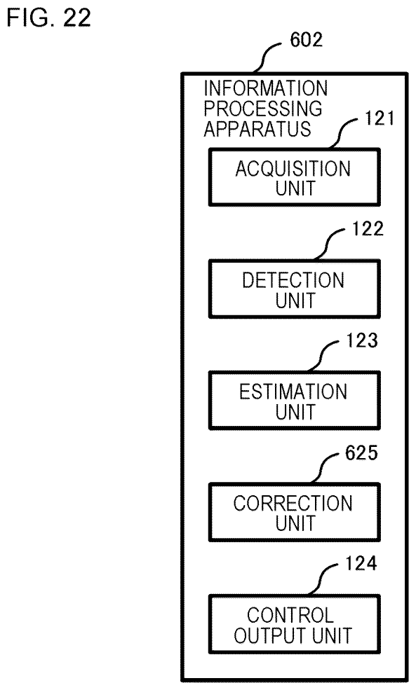

FIG. 22 is a diagram illustrating a functional configuration example of the information processing apparatus 602 according to the example embodiment 5. The information processing apparatus 602 includes a correction unit 625, in addition to a configuration included in the information processing apparatus 102 according to the example embodiment 1.

The correction unit 625 derives a control value by correcting an estimation result of an estimation unit 123 in such a way as to suppress vibration of a control value resulting from a delay before photographing is performed based on the control value. For example, the correction unit 625 performs proportional-integral-differential controller (PID) control using an estimation result of the estimation unit 123. PID control is an example of control in which a control value is derived by correcting an estimation result of the estimation unit 123, based on a timewise proportional value, differential value, and integral value of the estimation result of the estimation unit 123.

An equation (1) is an equation to be applied to algorithm of PID control, and equations (2) and (3) are equations in which the equation (1) is dispersed. U(t) is a control value. e(t) is a deviation amount (difference between a target value and a current value) of a focus. K_{P} is a proportional parameter of PID control. K_{I} is an integration parameter of PID control. K_{D} is a differential parameter of PID control.

$$\begin{matrix}[ Mathematical 1 ] & \\ U ( t ) = {K}_{P} e ( t ) + {K}_{I} \int e ( t ) dt + {K}_{D} \frac{de ( t )}{dt} & Equation ( 1 )\end{matrix}$$

$$\begin{matrix}[ Mathematical 2 ] & \\ U ( t ) = U ( t - 1 ) + Δ U ( t ) & Equation ( 2 )\end{matrix}$$

$$\begin{matrix}[ Mathematical 3 ] & \\ Δ U ( t ) = {K}_{P} ( e ( t ) - e ( t - 1 ) ) + {K}_{I} e ( t ) + {K}_{D} ( e ( t ) - 2 e ( t - 1 ) + e ( t - 2 ) ) & Equation ( 3 )\end{matrix}$$

The information processing system according to the present example embodiment may be physically configured similarly to the information processing system 100 according to the example embodiment 1.

### (Operation of Information Processing System According to Example Embodiment 5)

Information processing according to the present example embodiment includes first photographing processing and second photographing processing similar to those of the example embodiment 1, and focus control processing different from that of the example embodiment 1. Also in the present example embodiment, the focus control processing is performed by the information processing apparatus 602.

### (Example of Focus Control Processing According to Example Embodiment 5)

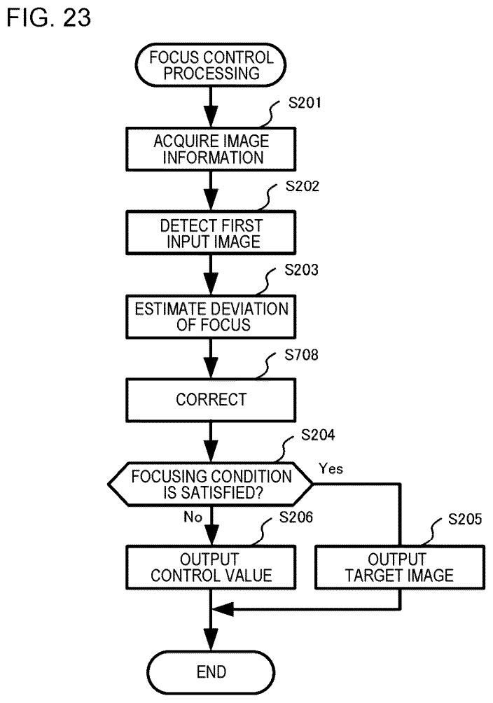

FIG. 23 is a flowchart illustrating one example of the focus control processing according to the example embodiment 5. As illustrated in FIG. 23, the focus control processing according to the present example embodiment includes steps S201 to S203, and further includes step S708 to be executed following these steps. The focus control processing according to the present example embodiment includes steps S204 to S206 to be executed following step S708. Steps S201 to S203 and steps S204 to S206 may be similar to each of those of the example embodiment 1.

The correction unit 625 derives a control value by correcting an estimation result in step S203 in such a way as to suppress vibration of a control value resulting from a delay before photographing is performed based on the control value (step S708).

Note that, in step S204, a control output unit 124 may decide whether a focusing condition is satisfied, based on the estimation result in step S203 similarly to the example embodiment 1. Further, in step S206, the control output unit 124 may output the control value derived in step S708, as a control value based on deviation of a focus estimated by an estimation unit 123.

In the focus control processing according to the present example embodiment, since an estimation result of the estimation unit 123 is corrected, it is possible to suppress vibration of a control value.

### Advantageous Effect

In the foregoing, according to the present example embodiment, the information processing apparatus 602 further includes the correction unit 625. The correction unit 625 derives a control value by correcting an estimation result of the estimation unit 123 in such a way as to suppress vibration of a control value resulting from a delay before photographing is performed based on the control value.

As described above, this enables to suppress vibration of a control value. Therefore, it becomes possible to adjust a focus on a target more accurately and stably.

According to the present example embodiment, the correction unit 625 derives a control value by correcting an estimation result of the estimation unit 123, based on a timewise differential value, integral value, and proportional value of the estimation result of the estimation unit 123.

As described above, this enables to suppress vibration of a control value. Therefore, it becomes possible to adjust a focus on a target more accurately.

### Example Embodiment 6

In the example embodiment 1, an example in which, upon detection of a person by a sensor, a focus is controlled based on an estimation result of the estimation unit 123 has been described. However, in a case where the photographing apparatus 101 performs photographing at a predetermined cycle, a person may be detected based on a target image. In an example embodiment 6, an example in which a person is detected based on a target image, and a control method being different between focus control for a first time, and focus control at a second time and thereafter is adopted is described.

In the present example embodiment, in order to simplify description, a point different from other example embodiments is mainly described.

An information processing system according to the present example embodiment includes a photographing apparatus 101 similar to that of the example embodiment 1, and an information processing apparatus 602 in place of the information processing apparatus 102 according to the example embodiment 1.

As described in the example embodiment 1, the photographing apparatus 101 generates a target image by each photographing by performing photographing at a predetermined cycle such as 40 times or 60 times during one second. In the present example embodiment, the photographing apparatus 101 may repeatedly perform photographing during operation.

Except for these points, the information processing system according to the present example embodiment may be configured similarly to the information processing system 100 according to the example embodiment 1.

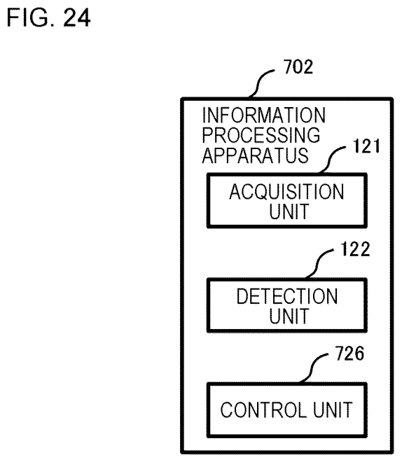

FIG. 24 is a diagram illustrating a functional configuration example of an information processing apparatus 702 according to the example embodiment 6. The information processing apparatus 702 includes an acquisition unit 121 and a detection unit 122 substantially similar to those of the example embodiment 1.

However, the photographing apparatus 101 according to the present example embodiment repeatedly performs photographing at a predetermined cycle during operation. Therefore, the acquisition unit 121 acquires time-series target images acquired by photographing a target.

Further, the detection unit 122 according to the present example embodiment further detects a distance (interocular distance) between both eyes included in a binocular image being a target image. Detection of an interocular distance may be performed by using a first training model that has been trained for detecting, from a binocular image, a right iris image and a left iris image by using the binocular image, as an input. The interocular distance is computed as a distance between center coordinates of the detected right iris and the detected left iris. A first correct answer value to be used in training of a first training model according to the present example embodiment may further include a left iris position.

The information processing apparatus 702 further includes a control unit 726 that outputs a control value for adjusting a focus.

Specifically, for example, the control unit 726 includes an estimation unit 123 as will be described later. Further, the control unit 726 outputs, as a control value, any of a first control value based on an estimated distance between a target and the photographing apparatus 101 (e.g., an optical system 112), and a second control value based on an estimation result of the estimation unit 123.

A first control value is a value to be derived based on one target image among time-series target images acquired for a common target by the acquisition unit 121. A second control value is a value to be derived based on a target image of a target photographed later than the one target image in a time-series manner among time-series target images acquired for a common target by the acquisition unit 121.

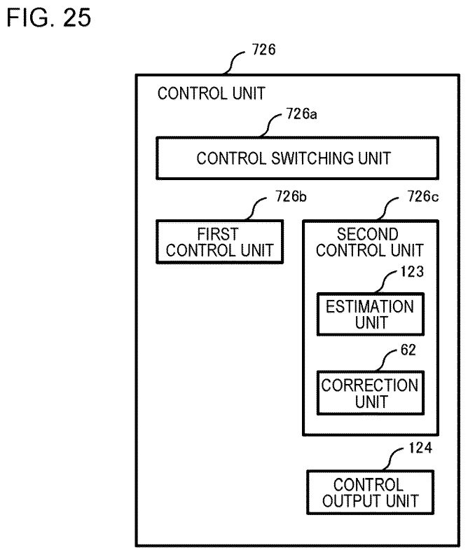

FIG. 25 is a diagram illustrating a functional configuration example of the control unit 726 according to the example embodiment 6.

The control unit 726 includes a control switching unit 726a, a first control unit 726b, a second control unit 726c, and a control output unit 124 similar to that of the example embodiment 1.

The control switching unit 726a switches an output destination of information (a first input image or an interocular distance) detected by the detection unit 122 between the first control unit 726b and the second control unit 726c.

In a case where a first input image detected by the detection unit 122 is, for example, based on photographing of a target for a first time, the control switching unit 726a outputs, to the first control unit 726b, an interocular distance regarding a target image in which the first input image is detected. Further, for example, in a case where a first input image detected by the detection unit 122 is not based on photographing of a target for a first time, the control switching unit 726a outputs the first input image to the second control unit 726c.

Specifically, for example, the control switching unit 726a decides, based on a first input image detected by the detection unit 122, whether the first input image is based on photographing of a target for a first time.

Normally, in a case where a target is the same, the detection unit 122 detects a first input image at a substantially same cycle as a photographing cycle. Since a target image (e.g., a binocular image) is not acquired during a time when a target is changed, the detection unit 122 cannot detect a first input image for a time longer than a photographing cycle.

Therefore, for example, the control switching unit 726a decides whether a first input image is based on photographing of a target for a first time, based on whether a time difference between timing when the detection unit 122 detects the first input image, and timing when the detection unit 122 detects a previous-time first input image is equal to or longer than a predetermined time. Note that, this decision method is not limited thereto, and may be changed as necessary.

In a case where it is decided that an image is a first input image based on photographing of a target for a first time, the control switching unit 726a outputs, to the first control unit 726b, an interocular distance detected by the detection unit 122 from a same target image as the first input image. In a case where it is decided that an image is not a first input image based on photographing of a target for a first time, the control switching unit 726a outputs, to the second control unit 726c (estimation unit 123), the first input image detected by the detection unit 122.

Upon acquisition of an interocular distance from the control switching unit 726a, for example, the first control unit 726b derives a first control value, based on the interocular distance. Specifically, in the present example embodiment, an interocular distance is equivalent to an estimated distance between a target and the photographing apparatus 101.

Note that, the first control unit 726b may derive an estimated value of an estimated distance between a target and the photographing apparatus 101, based on an interocular distance. Further, in a case where a person is present within a predetermined range, the first control unit 726b may derive a first control value, based on an estimated distance to be acquired from a distance measurement sensor (not illustrated) that estimates a distance to the person.

The second control unit 726c includes the estimation unit 123 similar to that of the example embodiment 1, and a correction unit 625. In the present example embodiment, a target image output from the control switching unit 726a may be acquired by the estimation unit 123.

The information processing system according to the present example embodiment may be physically configured similarly to the information processing system 100 according to the example embodiment 1.

### (Operation of Information Processing System According to Example Embodiment 6)

Information processing according to the present example embodiment includes first photographing processing and second photographing processing similar to those of the example embodiment 1, and focus control processing different from that of the example embodiment 1.

In the present example embodiment, during operation, the photographing apparatus 101 repeatedly performs any of the first photographing processing in a case where a control value is not acquired, and the second photographing processing in a case where a control value is acquired. Further, the information processing apparatus 702 repeatedly performs the focus control processing during operation.

### (Example of Focus Control Processing According to Example Embodiment 6)

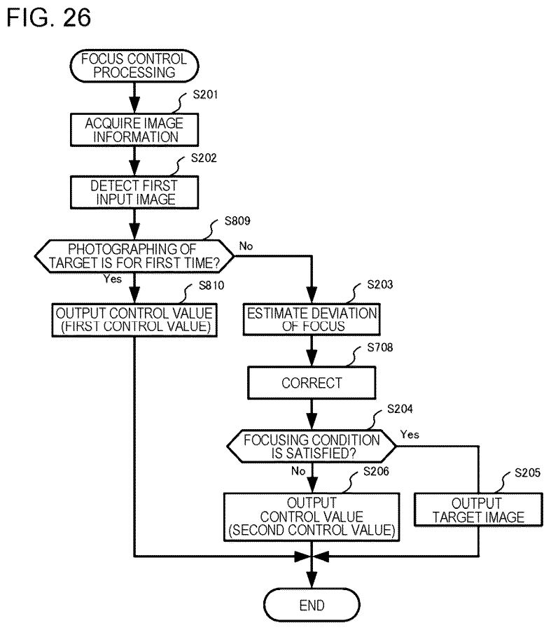

FIG. 26 is a flowchart illustrating one example of the focus control processing according to the example embodiment 6. As illustrated in FIG. 26, the focus control processing according to the present example embodiment includes steps S201 to S203 similar to those of the example embodiment 1, step S708 similar to that of the example embodiment 5, and steps S204 to S206 similar to those of the example embodiment 1.

However, in step S202 according to the present example embodiment, the detection unit 122 detects an interocular distance, based on a target image included in image information acquired in step S201. Further, a control value to be output in step S206 is a control value derived in step S708, and is equivalent to a second control value.

The focus control processing further includes steps S809 and S810. Step S809 is executed following step S102.

The control switching unit 726a decides, based on a first input image detected in step S202, whether the first input image is based on photographing of a target for a first time (step S809).

In a case where it is decided that an image is not the first input image based on photographing for a first time (step S809; No), the estimation unit 123 executes step S203 similar to that of the example embodiment 1.

In a case where it is decided that an image is the first input image based on photographing for a first time (step S809; Yes), the first control unit 726b derives a first control value, based on an interocular distance detected in step S202. Then, the first control unit 726b outputs the derived first control value, as a control value, and finishes the focus control processing.

In the focus control processing according to the present example embodiment, immediately after photographing of a certain target is performed for a first time, it is possible to adjust a focus, based on a first control value. This enables to adjust in such a way that a focus is roughly adjusted on a target. Further, after photographing of the same target is performed at a second time and thereafter, it is possible to accurately adjust a focus, based on a second control value.

### Advantageous Effect

According to the present example embodiment, the information processing apparatus 702 further includes the control unit 726 that outputs a control value for adjusting a focus. The control unit 726 includes the estimation unit 123, and outputs, as a control value, any of a first control value based on an estimated distance between a target and the photographing apparatus 101, and a second control value based on an estimation result of the estimation unit 123.

This enables to adjust a focus accurately by using a second control value, after roughly adjusting in such a way that the focus is adjusted on a target by using a first control value. Therefore, it is possible to adjust a focus at a high speed and accurately, as compared with a case where the first control value is not used.

According to the present example embodiment, the acquisition unit 121 acquires time-series target images acquired by photographing a target. A first control value is a value to be derived based on one target image among time-series target images. A second control value is a value to be derived based on a target image of a target photographed later than the one target image in a time-series manner.

This enables to adjust a focus accurately by using a second control value, after roughly adjusting in such a way that the focus is adjusted on a target by using a first control value. Therefore, it is possible to adjust a focus at a high speed and accurately, as compared with a case where the first control value is not used.

According to the present example embodiment, the information processing apparatus 702 further includes the first control unit 726b, and the switching control unit 726a.

The first control unit 726b derives a first control value, based on a distance between both eyes included in a target image. In a case where an image is a first input image based on photographing of a target for a first time, the switching control unit 726a outputs, to the first control unit, an interocular distance regarding a target image in which the first input image is detected. Further, in a case where an image is not a first input image based on photographing of a target for a first time, the switching control unit 726a outputs the first input image to the estimation unit 123.

This enables to adjust a focus accurately by using a second control value, after roughly adjusting in such a way that the focus is adjusted on a target by using a first control value. Therefore, it is possible to adjust a focus at a high speed and accurately, as compared with a case where the first control value is not used.

In the foregoing, example embodiments and modification examples according to the present disclosure have been described with reference to the drawings, however, these are examples of the present disclosure, and various configurations other than the above can also be adopted.

Further, in a plurality of flowcharts used in the above description, a plurality of processes (pieces of processing) are described in order, however, the order of execution of processes to be performed in each example embodiment is not limited to the order of description. In each example embodiment, the illustrated order of processes can be changed within a range that does not adversely affect a content. Further, the above-described example embodiments and modification examples can be combined, as far as contents do not conflict with each other.

A part or all of the above-described example embodiments may also be described as the following supplementary notes, but is not limited to the following.

1. An information processing apparatus including:
an acquisition unit that acquires a target image acquired by photographing a target by a photographing unit; and
an estimation unit that estimates deviation of a focus during photographing of the target image by using a training model that has been trained for deriving deviation of a focus during photographing of the target image by using, as an input, a first input image to be acquired from the target image.
   2. The information processing apparatus according to supplementary note 1, wherein
the training model is a model that has been trained for estimating deviation of a focus during the photographing by using training information, as an input.
   3. The information processing apparatus according to supplementary note 2, wherein
the training information includes a plurality of training images, and a correct answer value related to each of the plurality of training images.
   4. The information processing apparatus according to supplementary note 3, wherein
the plurality of training images include an image photographed in a different photographing environment.
   5. The information processing apparatus according to supplementary note 4, wherein
the photographing environment includes at least one of a target, and brightness.
   6. The information processing apparatus according to any one of supplementary notes 1 to 5, further including
a control unit that outputs a control value for adjusting the focus, wherein
the control unit includes the estimation unit, and outputs, as the control value, any of a first control value based on an estimated distance between the target and the photographing unit, and a second control value based on an estimation result of the estimation unit.
   7. The information processing apparatus according to supplementary note 6, further including
a correction unit that derives the second control value by correcting an estimation result of the estimation unit in such a way as to suppress vibration of the control value resulting from a delay before photographing is performed based on the control value.
   8. The information processing apparatus according to supplementary note 7, wherein
the correction unit derives the second control value by correcting an estimation result of the estimation unit, based on a timewise proportional value, differential value, and integral value of an estimation result of the estimation unit.
   9. The information processing apparatus according to any one of supplementary notes 6 to 8, wherein
the acquisition unit acquires the time-series target images acquired by photographing the target,
the first control value is a value to be derived based on one of the target image among the time-series target images, and
the second control value is a value to be derived based on a target image of the target photographed later than the one target image in a time-series manner among the time-series target images.
   10. The information processing apparatus according to supplementary note 9, further including:
a first control unit that derives the first control value, based on a distance between both eyes included in the target image; and
a switching control unit that outputs, to the first control unit, an interocular distance regarding the target image in which the first input image is detected in a case where an image is the first input image based on photographing of the target for a first time, and outputs the first input image to the estimation unit in a case where an image is not the first input image based on photographing of the target for a first time.
   11. The information processing apparatus according to any one of supplementary notes 6 to 10, further including
a detection unit that detects the first input image, based on the target image, wherein the first input image is an iris image.
   12. The information processing apparatus according to supplementary note 11, wherein
the detection unit further detects an iris diameter, based on the target image, and
the estimation unit estimates deviation of the focus by using the training model by further using an iris diameter, as an input.
   13. The information processing apparatus according to any one of supplementary notes 6 to 12, wherein
the first input image is an image to be acquired from a current target image, and
the estimation unit estimates deviation of the focus by using the training model by further using, as an input, a second input image to be acquired from a target image acquired by photographing the target in a past, and an amount of change of the control value based on the past target image.
   14. The information processing apparatus according to any one of supplementary notes 11 to 13, wherein
training models used by each of the detection unit and the estimation unit are separated from each other.
   15. The information processing apparatus according to any one of supplementary notes 1 to 14, further including
the photographing unit, wherein
the photographing unit generates the target image by photographing the target.
   16. An information processing system including:
the information processing apparatus according to any one of supplementary notes 1 to 14; and
the photographing unit that generates the target image by photographing the target.
   17. The information processing system according to supplementary note 15, wherein
the photographing unit includes
an adjustment unit that adjusts the focus by using a control value based on an estimation result of the estimation unit.
   18. An information processing method including,
by one or more computers:
acquiring a target image acquired by photographing a target by a photographing unit; and
estimating deviation of a focus during photographing of the target image by using a training model that has been trained for deriving deviation of a focus during photographing of the target image by using, as an input, a first input image to be acquired from the target image.
   19. A storage medium storing a program for causing one or more computers to execute:
acquiring a target image acquired by photographing a target by a photographing unit; and
estimating deviation of a focus during photographing of the target image by using a training model that has been trained for deriving deviation of a focus during photographing of the target image by using, as an input, a first input image to be acquired from the target image.
   20. A program for causing one or more computers to execute:
acquiring a target image acquired by photographing a target by a photographing unit; and
estimating deviation of a focus during photographing of the target image by using a training model that has been trained for deriving deviation of a focus during photographing of the target image by using, as an input, a first input image to be acquired from the target image.

### REFERENCE SIGNS LIST

100 Information processing system
101 Photographing apparatus
102, 202, 302, 402, 502, 602, 702 Information processing apparatus
111 Adjustment unit
112 Optical system
113 Imaging element
114 Image output unit
121 Acquisition unit
122, 322 Detection unit
123, 323, 423, 523 Estimation unit
124 Control output unit
625 Correction unit
726 Control unit
726a Control switching unit
726a Switching control unit
726b First control unit
726c Second control unit

What is claimed is:

1. An information processing apparatus comprising:
a memory configured to store instructions; and
a processor configured to execute the instructions to:
acquire a target image acquired by photographing a target by a photographing apparatus; and
estimate deviation of a focus during photographing of the target image by using a training model that has been trained for deriving deviation of a focus during photographing of the target image by using, as an input, a first input image to be acquired from the target image.

2. The information processing apparatus according to claim 1, wherein
the training model is a machine learning model that has been trained for estimating deviation of a focus during the photographing by using training information, as an input.

3. The information processing apparatus according to claim 2, wherein
the training information includes a plurality of training images, and a correct answer value related to each of the plurality of training images.

4. The information processing apparatus according to claim 3, wherein
the plurality of training images include an image photographed in a different photographing environment.

5. The information processing apparatus according to claim 4, wherein
the photographing environment includes at least one of a target, and brightness.

6. The information processing apparatus according to claim 1, wherein
the processor configured further to execute the instructions to:
output a control value for adjusting the focus, wherein
outputting the control value for adjusting the focus includes estimating deviation of the focus, and outputting, as the control value, any of a first control value based on an estimated distance between the target and the photographing apparatus, and a second control value based on the estimation result.

7. The information processing apparatus according to claim 6, wherein
the processor configured further to execute the instructions to:
derive the second control value by correcting an estimation result of the estimation unit in such a way as to suppress vibration of the control value resulting from a delay before photographing is performed based on the control value.

8. The information processing apparatus according to claim 7, wherein
the second control value is derived by correcting the estimation result, based on a timewise proportional value, differential value, and integral value of the estimation result.

9. The information processing apparatus according to claim 6, wherein
the acquired target image is included in the time-series target images acquired by photographing the target,
the first control value is a value to be derived based on one of the target image among the time-series target images, and
the second control value is a value to be derived based on a target image of the target photographed later than the one target image in a time-series manner among the time-series target images.

10. The information processing apparatus according to claim 9, wherein
the processor configured further to execute the instructions to:
derive the first control value, based on a distance between both eyes included in the target image; and
output, for deriving the first control value, an interocular distance regarding the target image in which the first input image is detected in a case where an image is the first input image based on photographing of the target for a first time, and output the first input image for estimating deviation of the focus in a case where an image is not the first input image based on photographing of the target for a first time.

11. The information processing apparatus according to claim 6, wherein
the processor configured further to execute the instructions to:
detect the first input image, based on the target image, wherein
the first input image is an iris image.

12. The information processing apparatus according to claim 11, wherein
the processor configured further to execute the instructions to:
detect an iris diameter, based on the target image, and
estimating deviation of the focus by using the training model further uses an iris diameter, as an input.

13. The information processing apparatus according to claim 6, wherein
the first input image is an image to be acquired from a current target image, and
estimating deviation of the focus by using the training model further uses, as an input, a second input image to be acquired from a target image acquired by photographing the target in a past, and an amount of change of the control value based on the past target image.

14. The information processing apparatus according to claim 11, wherein
training models used for estimating deviation of the focus and detecting the first input image are separated from each other.

15. The information processing apparatus according to claim 1, further comprising
the photographing apparatus, wherein
the photographing apparatus generates the target image by photographing the target.

16. An information processing system comprising:
the information processing apparatus according to claim 1; and
the photographing apparatus that generates the target image by photographing the target.

17. The information processing system according to claim 15, wherein
the photographing apparatus adjusts the focus by using a control value based on the estimation result.

18. An information processing method comprising,
by one or more computers:
acquiring a target image acquired by photographing a target by a photographing apparatus; and
estimating deviation of a focus during photographing of the target image by using a training model that has been trained for deriving deviation of a focus during photographing of the target image by using, as an input, a first input image to be acquired from the target image.

19. A non-transitory computer readable medium storing a program for causing one or more computers to execute:
acquiring a target image acquired by photographing a target by a photographing apparatus; and
estimating deviation of a focus during photographing of the target image by using a training model that has been trained for deriving deviation of a focus during photographing of the target image by using, as an input, a first input image to be acquired from the target image.
